(19) United States
(12) Patent Application Publication
(10) Pub. No.: US 2019/0097806 A1
(43) Pub. Date: Mar. 28, 2019

(54) System and Methods for Resolving Data Discrepancies in a Distributed System with Blockchain Controls

(71) Applicant: Walmart Apollo, LLC, Bentonville, AR (US)

(72) Inventors: David Lyle Vann, Bentonville, AR (US); Steven Jackson Lewis, Bentonville, AR (US); Rick Bough, Bentonville, AR (US)

(21) Appl. No.: 16/142,726

(22) Filed: Sep. 26, 2018

Related U.S. Application Data
(60) Provisional application No. 62/563,996, filed on Sep. 27, 2017.

(51) Int. Cl. H04L 9/32

(52) U.S. Cl. CPC H04L 9/3236; G06Q 10/083; H04L 2209/38

(57) ABSTRACT

Described in detail herein is a system for resolving data discrepancies. A central computing system can generate a master cryptographically verifiable ledger. The central computing system can be in communication with independently operated domains. The central computing system can receive an event associated with at least one physical object. In response to receiving the event, the central computing system can generate an additional block containing one or more new transaction records in the master cryptographically verifiable ledger. The central computing system, can transmit an alert the independently operated domain affected by the one or more new transaction records. The independently operated domain can generate an additional sub-block in a sub cryptographically verifiable ledger associated with the first independently operated domain.

### CROSS-REFERENCE TO RELATED PATENT APPLICATION

This application claims priority to U.S. Provisional Application 62/563,996 filed on Sep. 27, 2017, the content of which is hereby incorporated by reference in its entirety.

### BACKGROUND

Large distributed systems can encounter multiple errors and discrepancies when receiving updates to data.

### BRIEF DESCRIPTION OF THE FIGURES

Illustrative embodiments are shown by way of example in the accompanying figures and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a block diagram illustrating components of a system for resolving data discrepancies in accordance with an exemplary embodiment;

FIG. 2 is a block diagram illustrating components of the system for resolving data discrepancies in accordance with an exemplary embodiment;

FIG. 3 illustrates an exemplary network diagram of the system for resolving data discrepancies 100 in accordance with an exemplary embodiment;

FIG. 4 depicts an illustration of blocks as configured in accordance with an exemplary embodiment;

FIG. 5 depicts an illustration of transactions configured in accordance with an exemplary embodiment;

FIG. 6 depicts a flow diagram in accordance with an exemplary embodiment;

FIG. 7 depicts a process diagram as configured in accordance with an exemplary embodiment;

FIG. 8 depicts a system diagram configured in accordance with an exemplary embodiment;

FIG. 9 depicts a block diagram an exemplary computing device in accordance with an exemplary embodiment; and

FIG. 10 is a flowchart illustrating the process of a system for resolving data discrepancies using blockchain controls.

### DETAILED DESCRIPTION

Described in detail herein is a system for resolving data discrepancies. A central computing system can generate a master cryptographically verifiable ledger represented by a sequence of blocks. Each block in the master cryptographically verifiable ledger can contain one or more transactions records. Each subsequent block can contain a hash value associated with the previous block. The central computing system can be in communication with independently operated systems/domains. The central computing system can receive an event associated with at least one physical object. In response to receiving the event, the central computing system can generate an additional block in the master cryptographically verifiable ledger. The additional block can contain one or more new transaction records associated with the event.

The central computing system can determine which of the independently operated domains are affected by the event captured in the one or more transaction records included in the one additional block. The central computing system can transmit an alert to the independently operated domain(s) affected by the one or more new transaction records to notify at least one independently operated domain of the generation of the at least one additional block in the master cryptographically verifiable ledger. The independently operated domains each maintain a separate and distinct sub cryptographically verifiable ledger represented by a sequence of sub-blocks specific to the respective independently operated domain. For example, an independently operated domain can receive the alert and verify the event. The independently operated domain can generate an additional sub-block in a sub cryptographically verifiable ledger associated with the independently operated domain. The sub-block can contain the one or more transaction records associated with the event and a hash value associated with the additional block in the master cryptographically verifiable ledger as well as a hash value to the previous block in the sub cryptographically verifiable ledger associated with the independently operated domain. Embodiments of the system facilitates asynchronously communicating and reconciling event data from various disparate sources in real time, so that embodiments of the system can provide an accurate view of the system state and data at any particular point in time despite delays in propagation of data through the system. The system is configured to resolve data discrepancies within the central computing system and independently operated domains. Additionally, the system is configured to automatically verify changes/updates to data and audit the independently operated domains to assure the independently operated domains are reflecting the most current and accurate data.

The independently operated domain is further configured to transmit another alert to the central computing system and to one or more of the other independently operated domains. In response to receiving the alert, the central computing system can verify the one or more transactions in at least one additional sub-block that is generated by the independently operated domain in the sub cryptographically verifiable ledger.

In one embodiment, an independently operated domain can receive the other alert, verify the event, and generate an additional sub-block in a sub cryptographically verifiable ledger associated with the independently operated domain. The additional sub-block generated in the sub cryptographically verifiable ledger can contain the one or more transaction records associated with the event. In response to the independently operated domain generating the additional sub-block, the central computing system can determine another independently operated domain failed to generate an expected sub-block based on the alert, and triggers the independently operated domain that failed to generate the expected sub-block to generate the expected sub-block in the third sub cryptographically verifiable ledger associated with the independently operated domain.

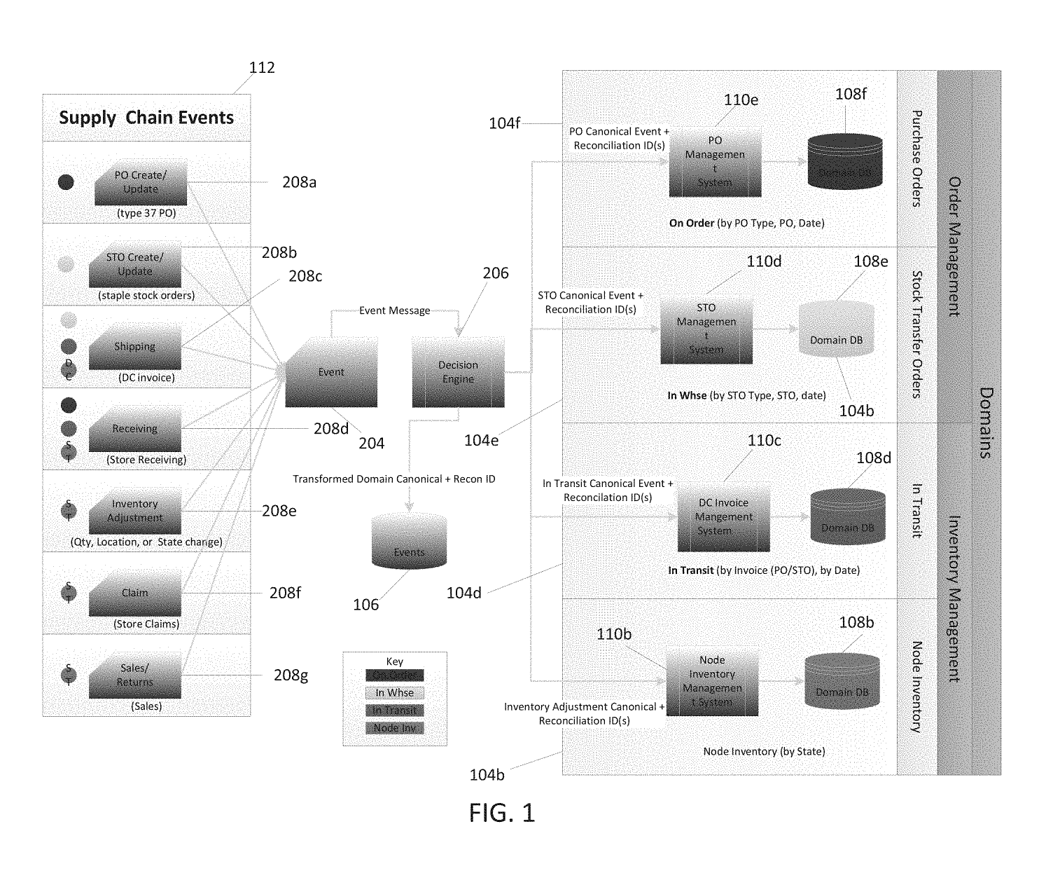

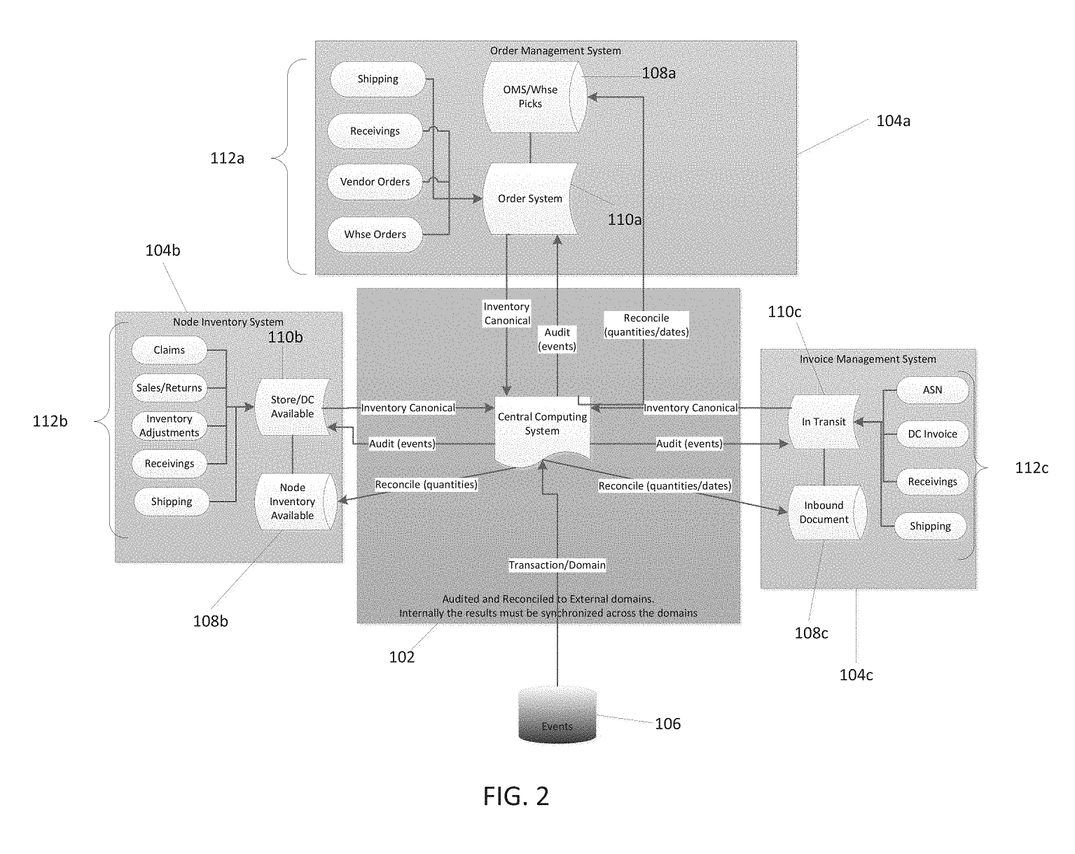

FIGS. 1-2 depict block diagrams illustrating components of a system 100 for resolving data discrepancies in accordance with an exemplary embodiment. Referring to FIGS. 1 and 2, the system 100 can include a central computing system 102, multiple independently operated domains 104, and an events database 106. As a non-limiting example, the independently operated domains 104 can include but are not limited to a computing system for an order data management system 104a, a computing system for a node inventory data management system 104b, and a computing system for an invoice data management system 104c.

Each of the independently operated domains 104 can include a domain data storage device 108 and a data management system 110. Each of the independently operated domains 104 can also generate various events 112. The events 112 can be associated with transaction records of physical objects. Continuing with the non-limiting example described above, the order data management system 104a can generate events 112a associated with shipping, receiving, vendor orders, and warehouse orders. The node inventory system 104b can generate events 112b associated with claims, sales/returns, inventory adjustment, receiving, and shipping. The invoice data management system 112 can generate events associated with Advance Ship Notice (ASN), Distribution Center, aka Warehouse (DC) invoice, receiving, and shipping.

Events 112 generated at the independently operated domains 104, can be transmitted to the central computing system 102, via the data management systems 110. The independently operated domains can update data in the domain databases 110 in response to the events 112. The central computing system 102 can store the events in the event database 106. The central computing system 102 can identify independently operated domains 104 affected by the received events and instruct the independently operated domains 104 to update the respective domain databases 110. For example, the data in the domain database of one of the independently operated domains may need to be updated based on an event that is generated by another one of the independently operated domains to maintain data consistency across the system 100. The central computing system 102 can recognize that the event affects the independently operated domains and can instruct the independently operated domain to update the data in the domain database 108 associated with the independently operated domain. In response, to updating the data in the domain database, the independently operated domain may generate its own event, which may propagate through the system 100 resulting in additional updates to data in the various domain databases 110 in the system.

The central computing system 102 can include an event queue 204 and a decision engine 206. The decision engine 206 can be an executable configured to implement system 100. As a non-limiting example, the central computing system 102 can receive events 112 such as a purchase order event 208a, STO Create/Update event 208b, shipping event 208c, receiving event 208d, inventory adjustment 208e, claims event 208f and sales return event 208g. The independently operated domains 104 can include a node inventory domain 104b, in-transit domain 104d, stock transfer order domain 104e and a purchase order domain 104f. Each of the domains 104a-f can be formed by one or more computing devices executing one or more applications to facilitate event generation and one or more database operations.

An event 112 such as a shipping event 208c from the node inventory domain 104b can be transmitted to the event queue 204. The decision engine 206 can pull a shipping event 208c from the event queue 204 and store the event in the event database 106. The decision engine 206 can determine the data in the shipping event 208c affects data in the purchase order domain 104f and the in-transit domain 104d. The decision engine 206 can instruct the purchase order domain 104f and in-transit domain 104d to update the data in the respective domain databases 108f and 108d, respectively.

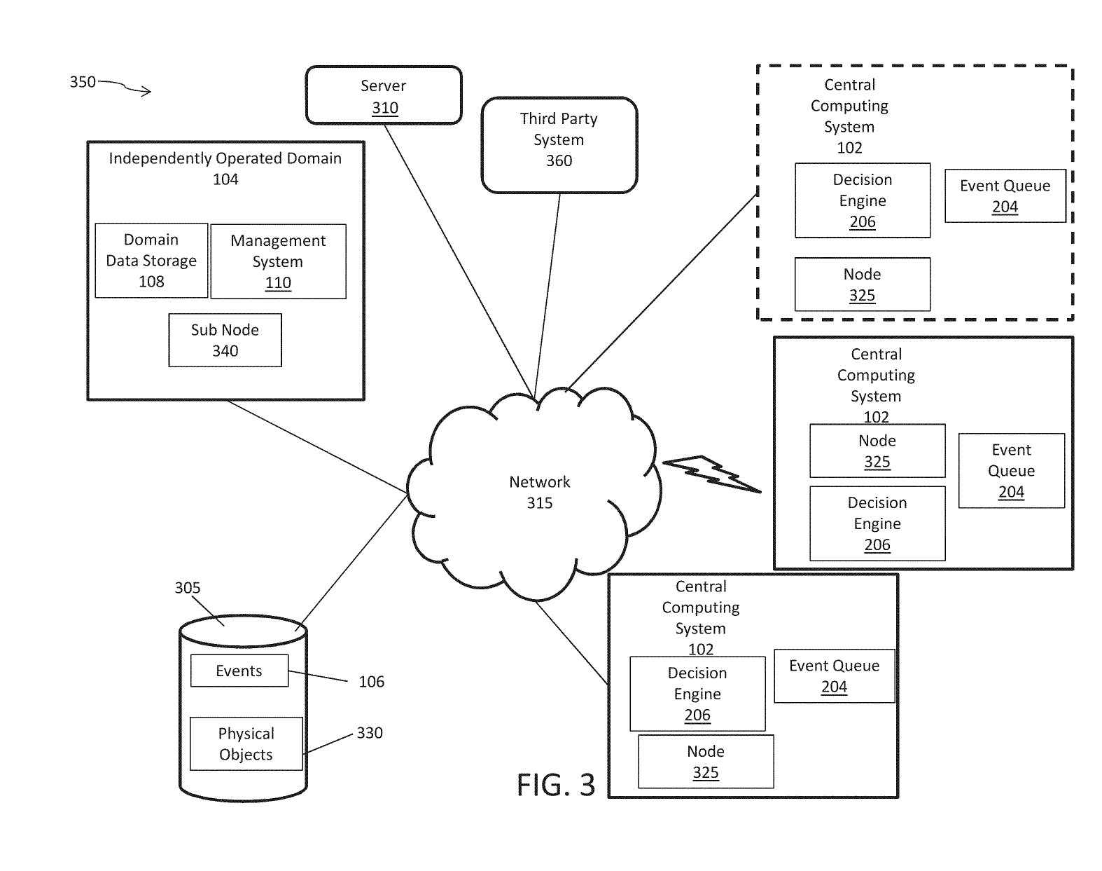

The event database 106 can be embodied as a master cryptographically verifiable ledger and the domain databases 108 can be embodied as separately maintained sub cryptographically verifiable ledgers. The master and sub cryptographically verifiable ledgers are described in further detail herein with reference to FIG. 3.

FIG. 3 illustrates an exemplary network diagram of an embodiment of the system 100 for resolving data discrepancies in accordance with an exemplary embodiment. In the present example embodiment, the system 100 can include one or more data storage devices 305, one or more central computing systems 102, and one or more independently operated domains 104. The central computing system 102 can be in communication with the data storage devices 305 and with the independently operated domains 104, via a communications network 315. The central computing system 102 can execute at least one instance of a decision engine 206. The central computing system 102 can include one or more nodes 325. Each of the one or more nodes 325 can store a copy of a master blockchain record and/or a shared ledger associated with events. The one or more nodes 325 can be configured to update the blocks in the master blockchain record based on the operation of transfer of one or more physical objects.

The independently operated domains 104 can include domain data storage 108, a data management system 110 and a sub node 340. The domain database 108 can be embodied as a blockchain storage system that is configured to store a blockchain record or a shared ledger based on events of data associated with the independently operated domain. The node 340 can store a copy of a sub blockchain record and/or a shared ledger, stored in the domain database 108, and associated events of data associated with the independently operated domain 104.

In an example embodiment, one or more portions of the communications network 315 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The central computing system 102 includes one or more computers or processors configured to communicate with the data storage devices 305, and the independently operated domains 104. The data storage devices 305 can store information/data, as described herein. For example, the data storage devices 305 can include an events database 106 and a physical objects database 330. The events database 106 can be embodied as a blockchain storage system that is configured to store a blockchain record or a shared ledger based on data affected by received events associated with physical objects. The events database 106 can be a master blockchain. As a non-limiting example, the event database 106 can store transaction records associated with physical objects such as invoices, purchase orders, inventory records, sales/returns records, vendor orders, claims, shipping orders, and/or receiving orders. The central computing system 102 can use the blocks of the blockchain to store transaction records associated with the events and to resolve data discrepancies between the independently operated domains 104, as described herein. The data storage devices 305 and the central computing system 102 can be located at one or more geographically distributed locations from each other. Alternatively, the data storage devices 305 can be included within the central computing system 102.

In an exemplary embodiment, the central computing system 102 can receive an event associated with one or more physical objects, from an independently operated domain 104 and/or a third party system 360. The event can indicate data affected based on the occurrence of the event. For example, the event can include transaction records associated with the one or more physical objects. The information can include identifiers associated with the physical objects and the location of the event. The central computing system 104 can execute the control engine 320 in response to receiving the event.

The node 325 can generate a new block in the events database 106. The block can store transaction records associated with the one or more physical objects based on the received event. The control engine 320 can query the physical objects database 330 to identify independently operated domains 104 for which data would be affected by the transaction records of the event. If the central computing system 102 receives the event from an independently operated domain 104. The identified independently operated domains 104 can be different than the independently operated domain which transmitted the event. The control engine 320 can transmit an alert of the creation of the new block in the events database 106. The alert can include the public and/or private key of the new block.

The identified independently operated domains 104 can receive the alert. The data management system 110 of an independently operated domain 104 which has received the alert, can access the transaction records in the new block stored in the events database 106. The data management system 110 can verify the occurrence of the event based on the transaction records. For example, the data management system 110 can query the physical objects database 330 and the domain database 108 to confirm whether the data in the transaction records corresponds with the data stored in the physical objects database 330 and the domain database 108. In response to verification of the event, the data management system 110 can query the physical objects database 330 to identify the data associated with the independently operated domain 104 that is affected by the accessed transaction records. The sub-node 340 can generate a new block in the domain database 108. The new block can contain new transaction records that can represent data associated with the independently operated domain 104 affected by the transaction records accessed from the new block stored in the events database 106 and a hash value associated with the block in the events database 106. The data management system 110 of the independently operated domain 104 can transmit an alert of the new block to the central computing system 102.

In response to the data management system 110 of the independently operated domain 104 accessing the transaction records in the new block stored in the events database 106, the node 325 can generate a new block which stores the information associated with the data management system 110 accessing the new block. The decision engine 206 can determine that an identified independently operated domain 104, to which an alert was sent, did not access the transaction records stored in the new block over a specified amount of time. In response to determining the identified independently operated domain 104 that has not accessed the transaction records stored in the new block, has also not generated a new block in the domain database 108, the decision engine 206 can trigger the sub node 340 to generate a new block in the domain database 108 of the independently operated domain 104. The new block can store new transaction records representing data affected based on the transaction records stored in the new block in the events database 106.

In one embodiment, in response to generating a new block stored in the domain database 108 of an independently operated domain 104, the data management system 110 of the independently operated domain 104 can query the physical objects database 330 to determine other independently operated domains 104 for which data is affected by the transactions records stored in the new block stored in the domain database 108 of the independently operated domain 104. The independently operated domain 104 can transmit an alert to the other domains. The alert can include the public and/or private key to the new block stored in the domain database 108. The other independently operated domains 104 can verify the event received by the central computing system 102 based on accessing the transaction records stored in the new block stored in the domain database 108. The other independently operated domains 104 can generate new blocks including transaction records in their respective domain databases 108. The transaction records can represent data affected by transaction records stored in the new block in the domain database 108 of the independently operated domain 104, which transmitted the alert.

In one embodiment, the data management system 110 can fail to verify the event. In response to failing to verify the event, the data management system 110 can transmit an alert to the central computing system 102. The central computing system 102 can delete the new block and/or generate a new block adjusting the transaction records to reflect the data accurately.

In one embodiment, the central computing system 102 can include an event queue 365. The event queue can be a data structure configured to receive events. It can be appreciated that the central computing system 102 can receive multiple events contemporaneously. The events can be received by the event queue and processed in a First In First Out (FIFO) order by the decision engine 206.

In one embodiment an independently operated domain 104 is configured to receive an alert associated with an event from the central computing system 102, verify the event, and generate an additional block in a domain database 108, the additional block containing the one or more transaction records associated with the event. In response to the independently operated domain generating the additional block, the central computing system can determines another independently operated domain failed to generate an expected sub-block based on the alert and triggers the generation of the expected sub-block in a domain database 108 of the other independently operated domain 104 based on the alert.

As a non-limiting example, system for resolving data discrepancies 100 can be implemented as in a retail store and/or e-commerce website. For example, the independently operated domains 104 can be domains for storing and processing inventory, sales, purchase orders, or retail store stock rooms. The physical objects can be embodied as products sold at the retail store and/or e-commerce website.

In one example, one independently operated domain 104 can be embodied as an inventory domain and another independently operated domain can be embodied as an in-transit domain. The in-transit domain can transmit an event associated with shipping of products from a warehouse to a retail store to the central computing system 102. The central computing system 102 can receive the event.

The node 325 can generate a new block in the events database 106. The block can store transaction records associated with the shipment of products from the warehouse. The control engine 320 can query the physical objects database 330 to identify independently operated domains 104 for which data would be affected by the transaction records of the event. The decision engine 104 can identify the inventory domain has an independently operated domain that is affected by the transaction records of the shipment of products from the warehouse to the retail store. The control engine can 320 transmit an alert of the creation of the new block in the events database 106 to the inventory domain. The alert can include the public and private key of the new block.

The inventory domain can receive the alert. The data management system 110 of the inventory domain, can access the transaction records in the new block stored in the events database 106. The data management system 110 can verify the occurrence of the event based on the transaction records. In response to verification of the event, the data management system 110 can query the physical objects database 330 to identify the data associated with the inventory domain that is affected by the accessed transaction records. The sub-node 340 can generate a new block in the domain database 108. The new block can contain new transaction records that represent data associated with the inventory domain affected by the transaction records accessed from the new block stored in the events database 106. For example, the inventory domain can increase the amount of products at the retail store based on the shipment of products from the warehouse to the retail store.

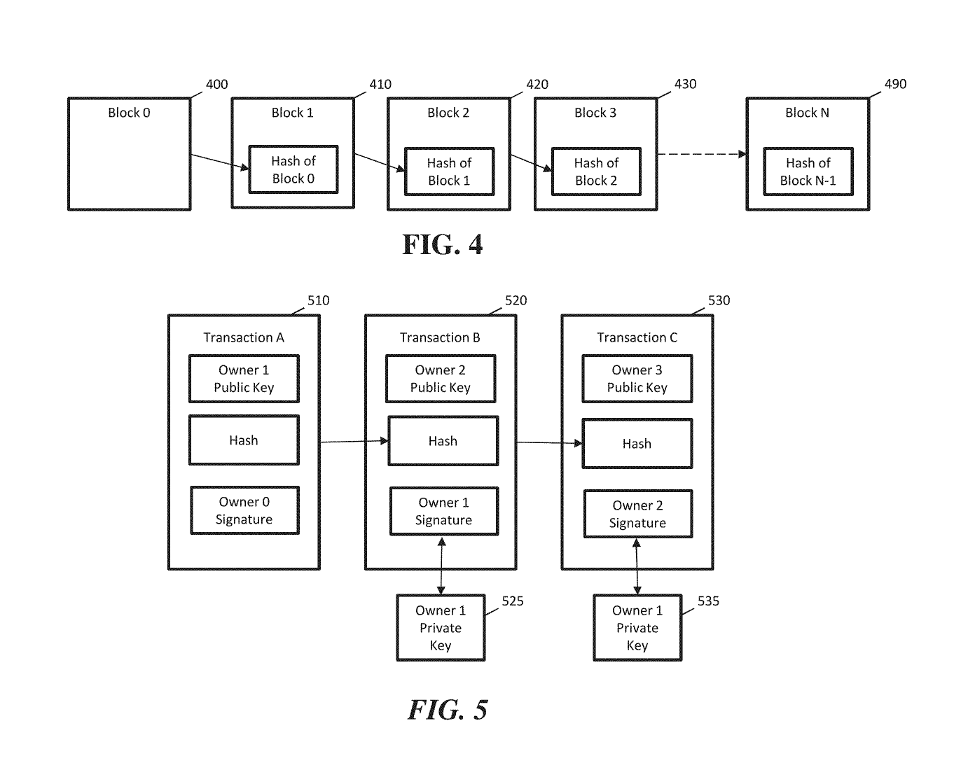

Descriptions of some embodiments of blockchain technology are provided with reference to FIGS. 4-8 herein. In some embodiments, blockchain technology may be utilized for resolving data discrepancies in a distributed system as described herein. One or more of the central computing systems and independently operated domains as described herein may comprise a node in a distributed blockchain system storing a copy of the blockchain record. Updates to the blockchain may comprise information associated with events associated with physical objects received by the central computing system, and one or more nodes on the system may be configured to incorporate one or more events into blocks to add to the distributed database.

Distributed database and shared ledger database generally refer to methods of peer-to-peer record keeping and authentication in which records are kept at multiple nodes in the peer-to-peer network instead of being kept at a trusted party. However, exemplary embodiments of the present disclosure can also utilize a private (trusted) system to maintain the blockchains. A blockchain may generally refer to a distributed database that maintains a growing and ordered list or chain of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, the system for resolving data discrepancies comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, e.g., resulting from in-field authentication of autonomous electronic devices, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it.

Now referring to FIG. 4, an illustration of a blockchain according to embodiments of the present disclosure is shown. As mentioned in above, with reference to FIG. 3, a blockchain comprises a hash chain or a hash tree in which each block added in the chain contains a hash of the previous block. In FIG. 4, block 0 400 represents a genesis block of the chain and can be generated in response to an event received associated with one or more physical objects. The block 0 400 can include information associated with the event associated with the physical objects and a hash key and a timestamp. The information associated with the event received associated with one or more physical objects can include information associated with the physical objects and information associated with the event, such as the delivery of the physical object, a quantity of the at least one physical object, name of the at least one physical object, type of the at least one physical object and size of the at least one physical object, and/or transfer of the ownership of physical objects. Block 1 410 can be generated in response to a verification of the event. The block 1 410 can contain a hash of block 0 400. The block 1 410 can include the information associated with the event and the physical objects. Otherwise, the block 1 410 can include information that an event was not verified. Additional blocks can be generated as additional requests are received and each block that is generated can include a hash of a previous block. For example, block 2 420 can be generated in response to a subsequent request and can contain a hash of block 1 410, block 3 430 can be generated in response to a yet another subsequent request and can contain a hash of block 2 420, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, the blocks generated by the central computing system can contain rules and data for authorizing different types of actions and/or parties who can take action as described herein. In some embodiments, transaction and block forming rules may be part of the software algorithm on each node. When a new block is being formed, any node on the system can use the prior records in the blockchain to verify whether the requested action is authorized. For example, a block may contain a public key associated with the user of a user device that purchased/acquired the physical object, this design that allows the user to show possession and/or transfer the digital license using a private key. Nodes may verify that the user is in possession of the one or more physical objects and/or is authorized to transfer the one or more physical objects based on prior events when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. Nodes can compete to provide proof-of-work to form a new block, and the first successful node of a new block earns a reward.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents an event in a block of a blockchain showing that owner 1 (recipient) (e.g., a central computing system creating a new block with transaction records associated with physical objects, based on a received event). Transaction A 510 contains owner's 1 public key and owner 0's signature for the transaction and a hash of a previous block. When owner 1, central computing system transmits an alert including the public key and private key, to an independently operated domain, of the newly generated block storing the transaction records, and the independently operated domain accesses the transaction record, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. If owner 2 (e.g., the independently operated domain) transmits an alert including the public key and private key, to an independently operated domain, of the newly generated block storing the transaction records to owner 3 (a different independently operated domain), a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 620. In some embodiments, when each event is created, the system may check previous events and the current owner's private and public key signature to determine whether the transaction is valid. In some embodiments, transactions are broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date event to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

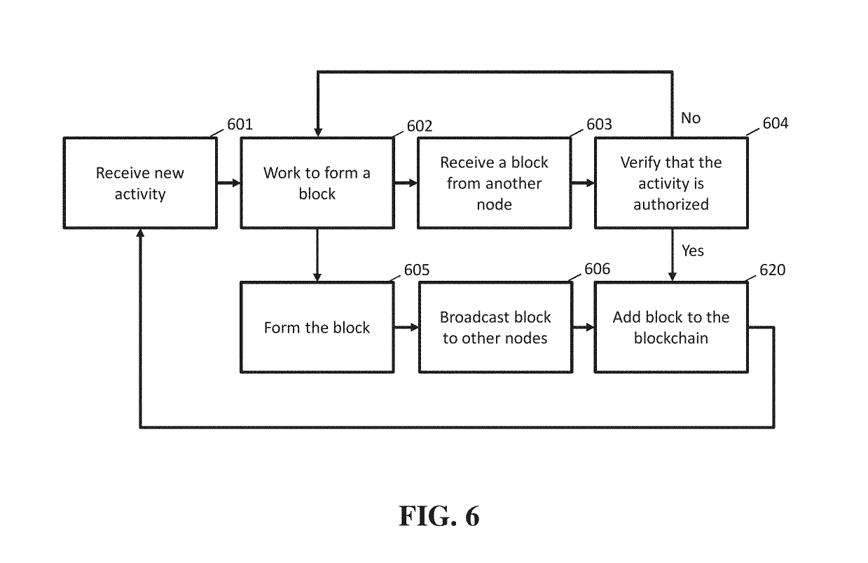

Now referring to FIG. 6, a flow diagram according to some embodiments is shown. In some embodiments, the steps shown in FIG. 6 may be performed by a computer system as described in FIG. 3, a server, a distributed server, a timestamp server, a blockchain node, and the like. In some embodiments, the steps in FIG. 6 may be performed by one or more of the nodes in a system using blockchain for record keeping.

In step 601, a node receives a new activity in response to receiving an event associated with physical objects. The new activity may comprise an update to the record being kept in the form of a blockchain with transaction records. In some embodiments, the new activity may be broadcasted to a plurality of nodes on the network prior to step 601. For example, the nodes of independently operated domains may be notified. In step 602, the node works to form a block to update the blockchain. In some embodiments, a block may comprise a plurality of activities or updates and a hash of one or more previous blocks in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem or form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In step 620, the node then adds the block to its copy of the blockchain. In the event that the node receives a block formed by another node in step 603 prior to being able to form the block, the node works to verify that the activity (e.g., authentication of transfer) recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

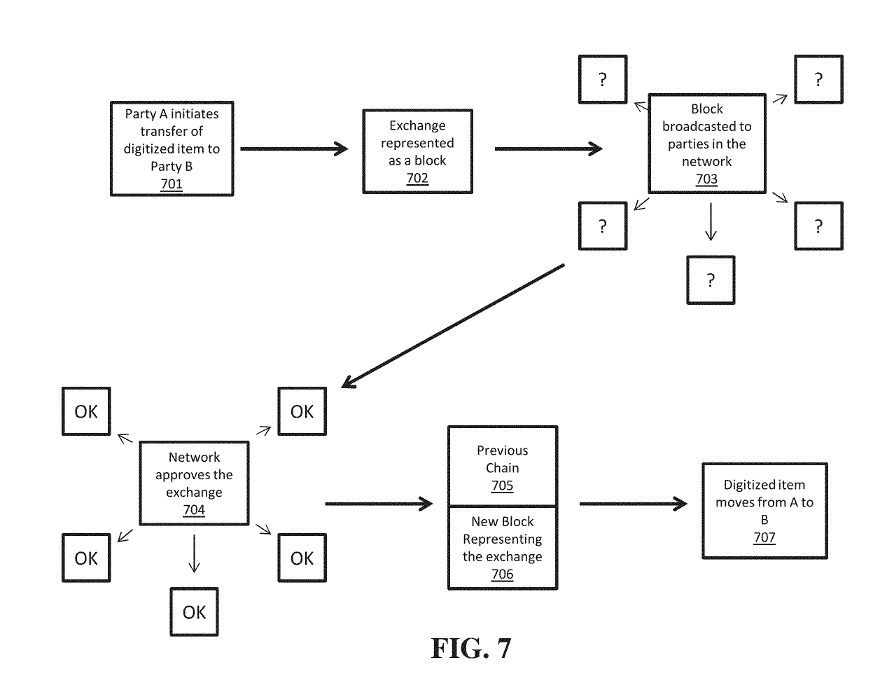

Now referring to FIG. 7, a process diagram, a blockchain update according to some implementations is shown. In step 701, party A (the central computing system) receives an event associated with physical objects. In some embodiments, Party A may be authenticated by signing the transaction with a private key that may be verified with a public key in the previous transaction associated with the physical objects. In step 702, the authentication initiated in step 701 is represented as a block. In some embodiments, the transaction may be compared with events in the longest chain in the distributed system to verify part A's authentication. In some embodiments, a plurality of nodes in the network may compete to form the block containing the authentication record. In some embodiments, nodes may be required to satisfy proof-of-work by solving a difficult mathematical problem to form the block. In some embodiments, other methods of proof such as proof-of-stake, proof-of-space, etc. may be used in the system. In step 703, the block is broadcasted to parties in the network. In step 704, nodes in the network authenticate party A by examining the block that contains the party A's authentication. In some embodiments, the nodes may check the solution provided as proof-of-work to approve the block. In some embodiments, the nodes may check the transaction against the event in the longest blockchain in the system to verify that the transaction is valid (e.g. party A is in possession of the object to be transferred). In some embodiments, a block may be approved with consensus of the nodes in the network. After a block is approved, the new block 706 representing the authentication is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the physical objects can be transferred from party A to party B (e.g., from the first mobile autonomous electronic device to the second autonomous electronic device).

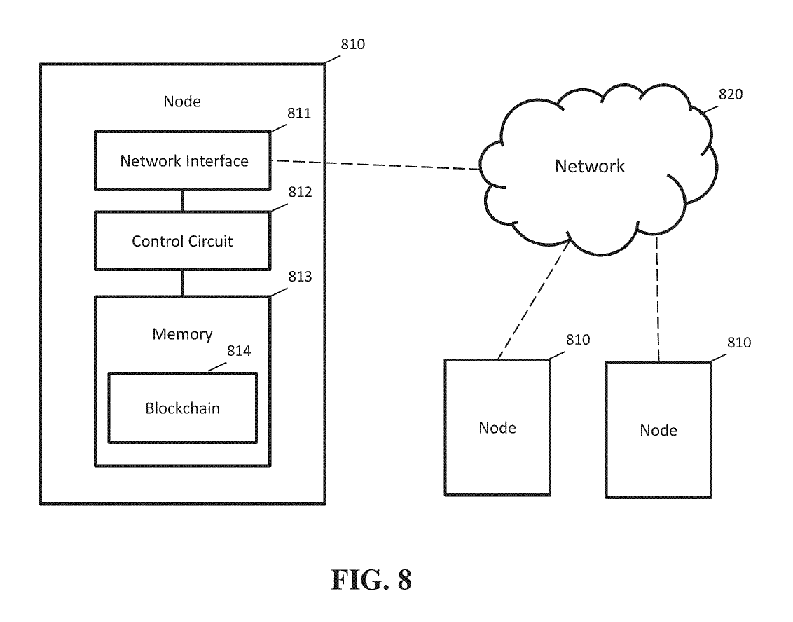

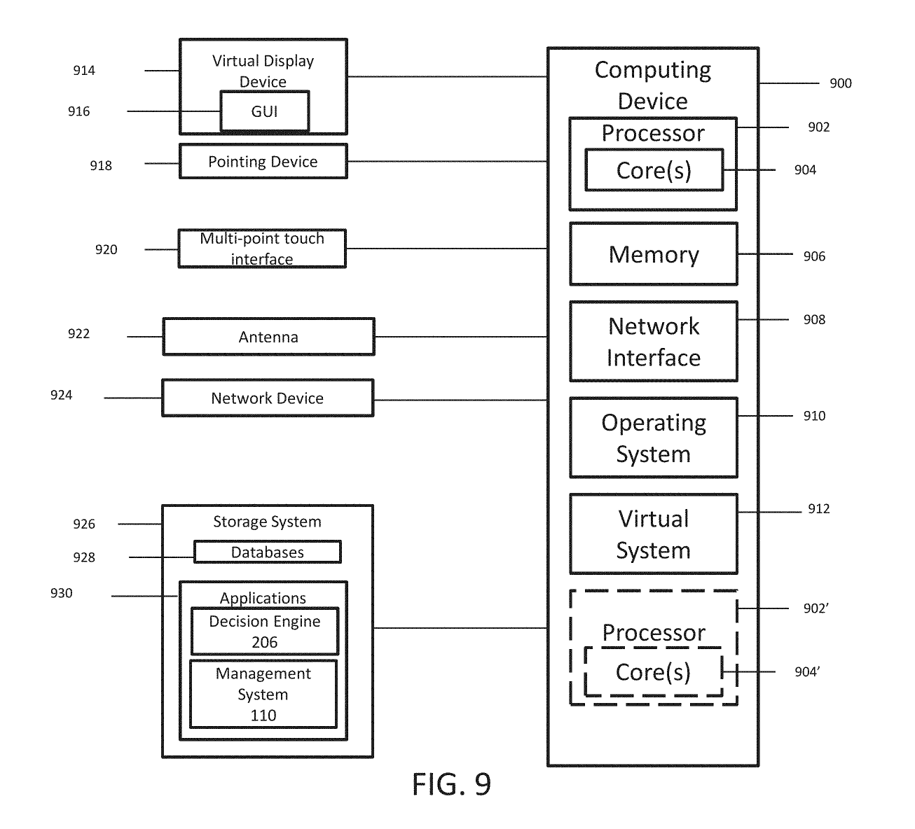

Now referring to FIG. 8, a system according to some embodiments is shown. A location verification system comprises a plurality of nodes 810 communicating over a network 820. In some embodiments, the nodes 810 may be comprise a distributed blockchain server and/or a distributed timestamp server. Each node 810 in the system comprises a network interface 811, a control circuit 812, and a memory 813.

The control circuit 812 may comprise a processor, a microprocessor, and the like and may be configured to execute computer readable instructions stored on a computer readable storage memory 813. The computer readable storage memory may comprise volatile and/or non-volatile memory and have stored upon it a set of computer readable instructions which, when executed by the control circuit 812, causes the node 810 update the blockchain 814 stored in the memory 813 based on communications with other nodes 810 over the network 820. In some embodiments, the control circuit 812 may further be configured to extend the blockchain 814 by processing updates to form new blocks for the blockchain 814. Generally, each node may store a version of the blockchain 814, and together, may form a distributed database. In some embodiments, each node 810 may be configured to perform one or more steps described with reference to FIGS. 6-8 herein.

The network interface 811 may comprise one or more network devices configured to allow the control circuit to receive and transmit information via the network 820. In some embodiments, the network interface 811 may comprise one or more of a network adapter, a modem, a router, a data port, a transceiver, and the like. The network 820 may comprise a communication network configured to allow one or more nodes 810 to exchange data. In some embodiments, the network 820 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown, once a block is formed, the block cannot be changed without redoing the work to satisfy census rules thereby securing the block from tampering. A malicious attacker would need to provide proof standard for each block subsequent to the one he/she seeks to modify, race all other nodes and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the events are computationally impractical to reverse. As such, sellers are protected from fraud and buyers are protected by the routine escrow mechanism.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

FIG. 9 is a block diagram of an example computing device for implementing exemplary embodiments of the present disclosure. Embodiments of the computing device 900 can implement embodiments of the system for resolving data discrepancies. For example, the computing device can be embodied as a portion of the central computing system, independently operated domains and/or third party system. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the decision engine 206 and the data management system 110) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof. The computing device 900 can receive data from input/output devices such as, an image capturing device 934. The image capturing device 934 can capture still or moving images. A user may interact with the computing device 900 through a visual display device 914, such as a computer monitor, which may display one or more graphical user interfaces 916, multi touch interface 920 and a pointing device 918.

The computing device 900 may also include one or more storage devices 926, such as a hard-drive, CD-ROM, or other computer readable media, for storing data and computer-readable instructions and/or software that implement exemplary embodiments of the present disclosure (e.g., applications such as the decision engine 206 and the data management system 110). For example, exemplary storage device 926 can include one or more databases 928 for storing information associated with physical objects and events associated with the physical objects. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the central computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

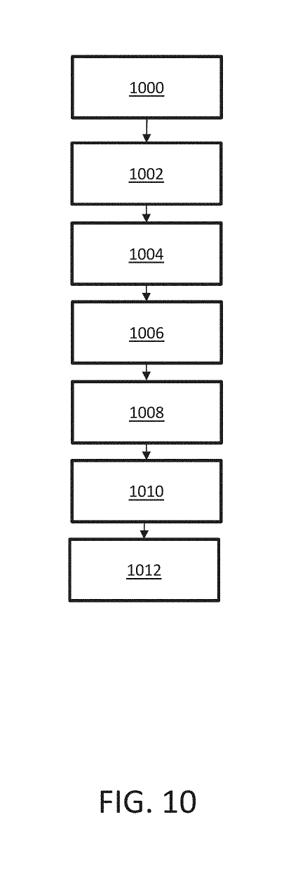

FIG. 10 is a flowchart illustrating an exemplary process of an embodiment of the system for resolving data discrepancies in accordance with the present disclosure. In operation 1000, a central computing system (e.g. central computing system 102 as shown in FIGS. 1 and 3) can generate a master cryptographically verifiable ledger (e.g. events database 106 as shown in FIGS. 1-3) represented by a sequence of blocks, each block containing one or more transactions records and each subsequent block containing a hash value associated with the previous block. The central computing system can be in communication with independently operated domains (e.g. independently operated domains 104 as shown in FIGS. 1-3). In operation 1002, the central computing system can receive an event (e.g. event 112 as shown in FIG. 1-2) associated with at least one physical object. In operation 1004, in response to receiving the event, the central computing system can generate an additional block containing one or more new transaction records associated with the event, in the master cryptographically verifiable ledger.

In operation 1006, the central computing system can determine an independently operated domains affected by the one or more transaction records included in the one additional block. In operation 1008, the central computing system, can transmit an alert the independently operated domain affected by the one or more new transaction records to notify at least one independently operated domain of the generation of the at least one additional block in the master cryptographically verifiable ledger. The independently operated domains are each associated with a sub cryptographically verifiable ledger (e.g. domain database 108 as shown in FIGS. 1-3) represented by a sequence of sub-blocks. In operation 1010 the first independently operated domain can receive alert and verify the event. In operation 1012, the independently operated domain can generate an additional sub-block in a first sub cryptographically verifiable ledger associated with the first independently operated domain. The first sub-block can contain the one or more transaction records associated with the event and a hash value associated with the additional block in the master cryptographically verifiable ledger.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for resolving data discrepancies in a distributed system, the system comprising:
a central computing system in communication with a plurality of independently operated domains, the central computing system configured to:
generate a master cryptographically verifiable ledger represented by a sequence of blocks, each block containing one or more transactions records and each subsequent block containing a hash value associated with the previous block;
receive an event associated with at least one physical object;
in response to receiving the event, generate at least one additional block containing one or more new events associated with the event, in the master cryptographically verifiable ledger;
determine at least a first one of the plurality of the independently operated domains affected by the one or more new events included in the at least one additional block;
transmit a first alert to at least one independently operated domain affected by the one or more new events to notify at least one independently operated domain of the generation of the at least one additional block in the master cryptographically verifiable ledger;
wherein the plurality of independently operated domains are each associated with a sub cryptographically verifiable ledger represented by a sequence of sub-blocks, and
wherein the first independently operated domain is configured to receive the first alert, verify the event, and generate a at least one additional sub-block in a first sub cryptographically verifiable ledger associated with the first independently operated domain, the first sub-block containing the one or more events associated with the event and a hash value associated with the at least one additional block in the master cryptographically verifiable ledger.

2. The system of claim 1, wherein the first independently operated domain is configured to transmit a second alert to the central computing system and one or more of the independently operated domains different than the first independently operated domain.

3. The system of claim 2, wherein in response to receiving the second alert, the central computing system is configured to verify the one or more transactions in the at least one additional sub-block generated by the first independently operated domain in the at least one sub cryptographically verifiable ledger.

4. The system of claim 2, wherein the one or more independently operated domains include a second independently operated domain and a third independently operated domain.

5. The system of claim 4, wherein the third independently operated domain is configured to receive the second alert, verify the event, and generate at least one additional sub-block in a third sub cryptographically verifiable ledger associated with the third independently operated domain, the additional sub-block generated in the third sub cryptographically verifiable ledger containing the one or more events associated with the event, and the third independently operated domain being further configured to transmit a third alert indicating the generation of the at least one additional block in the third sub cryptographically verifiable ledger to the central computing system.

6. The system of claim 5, wherein in response to receiving the third alert, the central computing system determines the second independently operated domain failed to generate an expected sub-block based on the second alert and triggers the generation of the expected sub-block in a second sub cryptographically verifiable ledger associated with the second independently operated domain based on the second alert.

7. The system of claim 1, wherein the one or more events are associated with a delivery of the at least one physical object.

8. The system of claim 1, wherein the one or more events include a quantity of the at least one physical object, name of the at least one physical object, type of the at least one physical object and size of the at least one physical object.

9. The system of claim 1, wherein the event is the transfer of ownership of the at least one physical object.

10. A method for resolving data discrepancies in a distributed system, the method comprising:
generating, via a central computing system in communication with a plurality of independently operated domains, a master cryptographically verifiable ledger represented by a sequence of blocks, each block containing one or more transactions records and each subsequent block containing a hash value associated with the previous block;
receiving, via the central computing system, an event associated with at least one physical object;
in response to receiving the event, generating, via the central computing system, at least one additional block containing one or more new events associated with the event, in the master cryptographically verifiable ledger;
determining, via the central computing system, at least a first one of the plurality of the independently operated domains affected by the one or more new events included in the at least one additional block;
transmitting, via the central computing system, a first alert to at least one independently operated domain affected by the one or more new events to notify at least one independently operated domain of the generation of the at least one additional block in the master cryptographically verifiable ledger;
wherein the plurality of independently operated domains are each associated with a sub cryptographically verifiable ledger represented by a sequence of sub-blocks, and
wherein the first independently operated domain is configured to receive the first alert, verify the event, and generate a at least one additional sub-block in a first sub cryptographically verifiable ledger associated with the first independently operated domain, the first sub-block containing the one or more events associated with the event and a hash value associated with the at least one additional block in the master cryptographically verifiable ledger.

11. The method of claim 10, further comprising transmitting, via the first independently operated domain, an second alert to the central computing system and one or more of the independently operated domains different than the first independently operated domain.

12. The method of claim 11, further comprising:
verifying, via the central computing system, the one or more transactions in the at least one additional sub-block generated by the first independently operated domain in the at least one sub cryptographically verifiable ledger, in response to receiving the second alert.

13. The method of claim 11, wherein the one or more independently operated domains include a second independently operated domain and a third independently operated domain.

14. The method of claim 13, further comprising:
receiving, via the third independently operated domain, the second alert;
verifying, via the third independently operated domain, the event; and
generating, via the third independently operated domain, at least one additional sub-block in a third sub cryptographically verifiable ledger associated with the third independently operated domain, the additional sub-block generated in the third sub cryptographically verifiable ledger containing the one or more events associated with the event, and the third independently operated domain being further configured to transmit a third alert indicating the generation of the at least one additional block in the third sub cryptographically verifiable ledger to the central computing system.

15. The method of claim 14, further comprising:
determining, via the central computing system, the second independently operated domain failed to generate an expected sub-block based on the second alert; and
triggering, via the central computing system, the generation of the expected sub-block in a second sub cryptographically verifiable ledger associated with the second independently operated domain based on the second alert, in response to receiving the third alert.

16. The method of claim 11, wherein the one or more events are associated with a delivery of the at least one physical object.

17. The method of claim 11, wherein the one or more events include a quantity of the at least one physical object, name of the at least one physical object, type of the at least one physical object and size of the at least one physical object.

18. The method of claim 11, wherein the event is the transfer of ownership of the at least one physical object.
